(19) United States
(12) Patent Application Publication
(10) Pub. No.: US 2021/0257637 A1
(43) Pub. Date: Aug. 19, 2021

(54) FUEL CELL SYSTEM AND CONTROL METHOD THEREOF

(71) Applicant: TOYOTA JIDOSHA KABUSHIKI KAISHA, Toyota-shi (JP)

(72) Inventor: Ryouichi NAMBA, Okazaki-shi (JP)

(21) Appl. No.: 17/159,452

(22) Filed: Jan. 27, 2021

(30) Foreign Application Priority Data
Feb. 19, 2020 (JP) 2020-026102

(51) Int. Cl. H01M 8/04746; H01M 8/04089; H01M 8/04082; H01M 8/04225; H01M 8/04223; H01M 8/04302; H01M 8/0444; H01M 8/04701; H01M 8/04111; H01M 8/04664

(52) U.S. Cl. CPC H01M 8/04753; H01M 8/04089; H01M 8/04201; H01M 8/04225; H01M 8/04268; H01M 8/04664; H01M 8/04462; H01M 8/04701; H01M 8/04761; H01M 8/04111; H01M 8/04253; H01M 8/04302

(57) ABSTRACT

A fuel cell system includes a controller which controls operations of an oxidizing gas supply/discharge system and a fuel gas supply/discharge system, and controls power generation of a fuel cell stack, and, when detecting a fuel gas concentration abnormality that a fuel gas concentration in an exhaust gas exceeds an allowable value during the power generation of the fuel cell stack, the controller increases a flow rate of air fed by an air compressor, and controls an opening of a bypass valve to execute exhaust gas dilution control for increasing a ratio of the flow rate of the air flowing out from the bypass piping to an exhaust gas piping with respect to the flow rate of the air to be supplied to the fuel cell stack.

### CROSS REFERENCE TO RELATED APPLICATIONS

This application claims priority to Japanese Patent Application No. 2020-026102, filed Feb. 19, 2020, the disclosure of which is incorporated by reference herein in its entirety.

### BACKGROUND

### Field

The present disclosure relates to a fuel cell system and a control method thereof.

### Related Art

There is a case where, when an oxidizing gas is insufficient in a cathode, a fuel gas is produced in the cathode in a fuel cell stack. When hydrogen is used as the fuel gas, the fuel gas produced in the cathode in this way is also referred to as “pumping hydrogen”. Production of a large amount of the fuel gas in the cathode causes an increase in a fuel gas concentration in an exhaust gas of a fuel cell stack to be discharged into the atmosphere. For example, when detecting production of pumping hydrogen during execution of a warm-up operation, a fuel cell system of following Japanese Patent Application Laid-Open No. 2010-61960 increases a supply amount of air to a cathode of a fuel cell stack, reduces the pumping hydrogen, and thereby resolves an increase in a hydrogen concentration in an exhaust gas.

Patent Literature 1: JP-A-2010-61960

However, if a supply amount of an oxidizing gas to the fuel cell stack is increased irrespectively of requested power for the fuel cell stack to resolve an increase in the fuel gas concentration in the exhaust gas, a power generation state of the fuel cell stack is likely to significantly fluctuate to an undesirable degree. Thus, there is still a room for improvement of a countermeasure for resolving the increase in the fuel gas concentration in the exhaust gas in the fuel cell stack.

### SUMMARY

In one aspect of the present disclosure, a fuel cell system is provided. The fuel cell system includes: a fuel cell stack which includes a cathode to which an oxidizing gas is supplied and an anode to which a fuel gas is supplied; an oxidizing gas supply/discharge system which executes supply control of the oxidizing gas to the cathode, and includes a cathode supply piping which is connected with an inlet of the cathode, an exhaust gas piping which is connected with an outlet of the cathode and discharges into an atmosphere an exhaust gas containing a cathode off-gas discharged from the cathode, a bypass piping which connects the cathode supply piping and the exhaust gas piping, an air compressor which compresses air containing the oxidizing gas to feed to the cathode supply piping, and a bypass valve which adjusts a flow rate of the air flowing into the bypass piping; a fuel gas supply/discharge system which executes supply control of the fuel gas to the anode; a fuel gas sensor which is provided in the exhaust gas piping, and detects a fuel gas concentration in the exhaust gas; a controller which controls operations of the oxidizing gas supply/discharge system and the fuel gas supply/discharge system, and controls power generation of the fuel cell stack, and, when detecting a fuel gas concentration abnormality that the fuel gas concentration exceeds a predetermined allowable value during the power generation of the fuel cell stack, the controller increases the flow rate of the air fed by the air compressor, and controls an opening of the bypass valve to execute exhaust gas dilution control for increasing a ratio of the flow rate of the air flowing out from the bypass piping to the exhaust gas piping with respect to the flow rate of the air to be supplied to the fuel cell stack.

### BRIEF DESCRIPTION OF THE DRAWINGS

FIG. 1 is a schematic view illustrating a configuration of a fuel cell system;

FIG. 2 is a schematic view illustrating a more detailed configuration of the fuel cell system;

FIG. 3 is a schematic view illustrating an electrical configuration of the fuel cell system;

FIG. 4 is a schematic internal block diagram of a control device;

FIG. 5 is an explanatory view illustrating temperature characteristics of a secondary battery;

FIG. 6 is an explanatory view illustrating a flow of start processing in the fuel cell system;

FIG. 7 is an explanatory view illustrating a flow of exhaust gas dilution control; and

FIG. 8 is an explanatory view illustrating one example of a control map of an air compressor.

### DETAILED DESCRIPTION

### 1. Embodiment

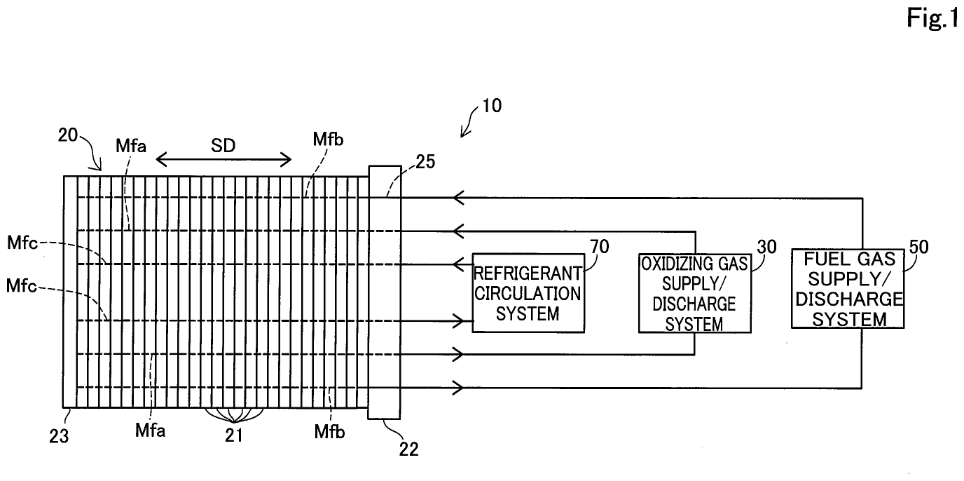

FIG. 1 is a schematic view illustrating a configuration of a fuel cell system 10 according to the present embodiment. The fuel cell system 10 is mounted on, for example, a fuel cell vehicle, and outputs power requested by a load described below or requested power for external power feeding. The fuel cell system 10 includes a fuel cell stack 20, an oxidizing gas supply/discharge system 30, a fuel gas supply/discharge system 50 and a refrigerant circulation system 70.

The fuel cell stack 20 includes a plurality of fuel battery cells 21, and a pair of end terminals 22 and 23. Each of a plurality of fuel battery cells 21 has a plate shape, and is stacked in a stacking direction SD which is a thickness direction. The fuel battery cell 21 is a power generation element which can generate power even alone. The fuel battery cell 21 receives a supply of an oxidizing gas and a fuel gas which are reactive gases, and generates power as a result of an electrochemical reaction of these gases. In the present embodiment, the fuel battery cell 21 is configured as a polymer electrolyte fuel cell. Furthermore, in the present embodiment, oxygen is used as the oxidizing gas, and hydrogen is used as the fuel gas.

The fuel battery cell 21 includes a membrane electrode assembly on which an anode and a cathode which are electrodes carrying catalysts on both surfaces of electrolyte membranes configured as polymer resin membranes having ionic conductivity are arranged. The fuel battery cell 21 further includes two separators which sandwich the membrane electrode assembly. Illustration of the membrane electrode assembly and the separators is omitted. An opening portion (illustration thereof is omitted) which forms manifolds Mfa and Mfb which cause the reactive gas and a reactive off-gas having passed a power generation portion of the membrane electrode assembly to circulate is provided at an outer circumferential end portion of each fuel battery cell 21. The manifolds Mfa and Mfb are connected by way of multipoint connection with the power generation portion of the membrane electrode assembly. The manifold Mfa is connected with the cathode, and the manifold Mfb is connected with the anode. Furthermore, an opening portion (illustration thereof is omitted) which forms a manifold Mfc which causes a refrigerant to circulate is provided at the outer circumferential end portion of each fuel battery cell 21. The manifold Mfc is connected with a refrigerant flow path which is formed between the neighboring separators.

A pair of end terminals 22 and 23 are arranged at both end portions in the stacking direction SD of a plurality of fuel battery cells 21. More specifically, the first end terminal 22 is arranged at one end portion of the fuel cell stack 20, and the second end terminal 23 is arranged at the other end portion. Opening portions 25 which are through-holes for forming the manifolds Mfa, Mfb and Mfc are formed in the first end terminal 22. On the other hand, these opening portions 25 are not formed in the second end terminal 23. In the fuel cell stack 20, the fuel gas, the oxidizing gas and the refrigerant are supplied to the fuel cell stack 20 from the first end terminal 22 side, and are discharged.

The oxidizing gas supply/discharge system 30 includes an oxidizing gas supply function, an oxidizing gas discharge function and an oxidizing gas bypass function. The oxidizing gas supply function is a function of supplying air containing the oxidizing gas to the cathode of the fuel battery cell 21. The oxidizing gas discharge function is a function of discharging, to an outside, the oxidizing gas discharged from the cathode of the fuel battery cell 21, an inert gas and an exhaust gas (also referred to as a “cathode off-gas”) containing waste water. In addition, there is a case where the cathode off-gas further contains a fuel gas produced in the cathode described below. The oxidizing gas bypass function is a function of discharging, to an outside, part of air containing the oxidizing gas to be supplied without the fuel battery cell 21.

The fuel gas supply/discharge system 50 includes a fuel gas supply function, a fuel gas discharge function and a fuel gas circulation function. The fuel gas supply function is a function of supplying the fuel gas to the anode of the fuel battery cell 21. The fuel gas discharge function is a function of discharging to the outside the fuel gas discharged from the anode of the fuel battery cell 21, an inert gas and an exhaust gas (also referred to as an “anode off-gas”) containing waste water. The fuel gas circulation function is a function of circulating the anode off-gas in the fuel cell system 10.

The refrigerant circulation system 70 includes a function of circulating the refrigerant to the fuel cell stack 20 and adjusting the temperature of the fuel cell stack 20. For example, an antifreeze solution such as ethylene glycol, and a liquid such as water are used as the refrigerant.

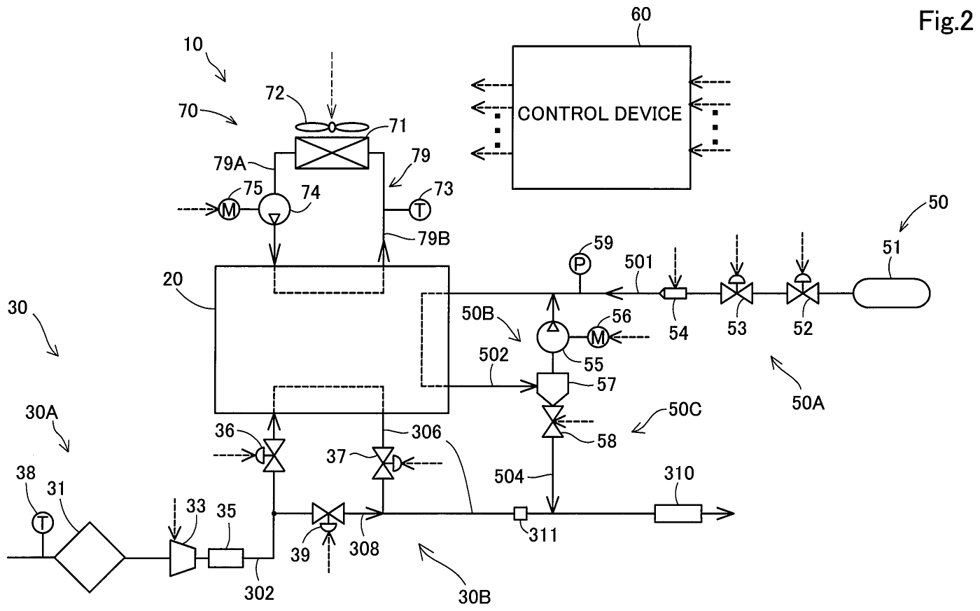

FIG. 2 is a schematic view illustrating a detailed configuration of the fuel cell system 10. The fuel cell system 10 includes a control device 60 in addition to the above-described fuel cell stack 20, oxidizing gas supply/discharge system 30, fuel gas supply/discharge system 50 and refrigerant circulation system 70. The control device 60 controls an operation of the fuel cell system 10. Details of the control device 60 will be described later.

The oxidizing gas supply/discharge system 30 includes an oxidizing gas supply system 30A and an oxidizing gas discharge system 30B. The oxidizing gas supply system 30A supplies air containing the oxidizing gas to the cathode of the fuel cell stack 20. The oxidizing gas supply system 30A includes a cathode supply piping 302, an outdoor temperature sensor 38, an air cleaner 31, an air compressor 33, an intercooler 35 and an inlet valve 36.

The cathode supply piping 302 is connected with an inlet of the cathode of the fuel cell stack 20 to form a supply flow path of air to the cathode of the fuel cell stack 20. The outdoor temperature sensor 38 measures the temperature of the air to be taken in the air cleaner 31 as an outdoor temperature. The measurement result of the outdoor temperature sensor 38 is transmitted to the control device 60. The air cleaner 31 is provided on an upstream side of the air compressor 33 in the cathode supply piping 302, and removes foreign materials in the air to be supplied to the fuel cell stack 20.

The air compressor 33 is provided in the cathode supply piping 302 which is on an upstream side of the fuel cell stack 20, and feeds, to the cathode, air compressed at a pressure in accordance with a command from the control device 60. According to the present embodiment, the air compressor 33 has operation characteristics which can change a flow rate of the air to be fed while constantly maintaining power consumption. The operation characteristics can be realized by configuring the air compressor 33 as, for example, a turbo compressor. Furthermore, the operation characteristics are determined based on a configuration of an impeller of the air compressor 33. The control device 60 commands a pressure ratio and the power consumption of the air compressor 33 by using the operation characteristics to control a flow rate of the air fed by the air compressor 33. The “pressure ratio” means a ratio of the pressure of the air flowing into the air compressor 33 with respect to the pressure of the air fed from the air compressor 33. Details of the operation characteristics of the air compressor 33 and control which uses the operation characteristics will be described later.

The intercooler 35 is provided on a downstream side of the air compressor 33 in the cathode supply piping 302. The intercooler 35 cools air which is compressed to have a high temperature by the air compressor 33. The inlet valve 36 adjusts the pressure of air on a cathode inlet side of the fuel cell stack 20. The inlet valve 36 is configured as an electromagnetic valve or a motor operated valve whose opening is controlled by the control device 60. The inlet valve 36 may be configured as an on-off valve which mechanically opens when air of the predetermined pressure flows thereinto.

The oxidizing gas discharge system 30B discharges a cathode off-gas to an outside of a fuel cell vehicle. The oxidizing gas discharge system 30B includes an exhaust gas piping 306 and a bypass piping 308.

The exhaust gas piping 306 is connected with an outlet of the cathode of the fuel cell stack 20 to form a discharge flow path of a cathode off-gas. The exhaust gas piping 306 includes a function of discharging into an atmosphere the exhaust gas of the fuel cell stack 20 containing the cathode off-gas. The exhaust gas discharged from the exhaust gas piping 306 into the atmosphere contains an anode off-gas and air flowing out from the bypass piping 308 in addition to the cathode off-gas. A muffler 310 which reduces an exhaust sound of the exhaust gas is provided at a downstream side end portion of the exhaust gas piping 306.

The exhaust gas piping 306 is provided with an outlet valve 37. The outlet valve 37 is arranged on an upstream side of a point at which the bypass piping 308 is connected in the exhaust gas piping 306. The outlet valve 37 is configured as an electromagnetic valve or a motor operated valve. The opening is adjusted by the control device 60 so that the outlet valve 37 adjusts a back pressure of the cathode of the fuel cell stack 20.

The bypass piping 308 connects the cathode supply piping 302 and the exhaust gas piping 306 without passing the fuel cell stack 20. The bypass piping 308 is provided with a bypass valve 39. The bypass valve 39 is configured as an electromagnetic valve or a motor operated valve. When the bypass valve 39 is opened, part of air flowing in the cathode supply piping 302 flows into the exhaust gas piping 306 through the bypass piping 308. The control device 60 adjusts the flow rate of air flowing into the bypass piping 308 by adjusting an opening of the bypass valve 39.

The exhaust gas piping 306 is provided with a fuel gas sensor 311. The fuel gas sensor 311 detects a fuel gas concentration in the exhaust gas flowing in the exhaust gas piping 306, and transmits a detection result of the fuel gas concentration to the control device 60. According to the present embodiment, the fuel gas sensor 311 is configured as a hydrogen concentration sensor. Furthermore, according to the present embodiment, the fuel gas sensor 311 is provided on an upstream side of a joining point of the exhaust gas piping 306 and an anode discharge piping 504. Consequently, the fuel gas sensor 311 can detect a fuel gas concentration in a cathode off-gas as the fuel gas concentration in the exhaust gas. The fuel gas concentration in the cathode off-gas indicates the amount of the fuel gas which is produced in the cathode and is discharged from the cathode.

The fuel gas supply/discharge system 50 includes a fuel gas supply system 50A, a fuel gas circulation system 50B and a fuel gas discharge system 50C.

The fuel gas supply system 50A supplies the fuel gas to the anode of the fuel cell stack 20. The fuel gas supply system 50A includes an anode supply piping 501, a fuel gas tank 51, an on-off valve 52, a regulator 53, an injector 54 and a pressure sensor 59.

The anode supply piping 501 is connected with the fuel gas tank 51 which is a fuel gas supply source, and an inlet of the anode of the fuel cell stack 20 to form a supply flow path of the fuel gas to the anode of the fuel cell stack 20. The fuel gas tank 51 stores, for example, a hydrogen gas of a high pressure. The on-off valve 52 is provided in front of the fuel gas tank 51 in the anode supply piping 501. The on-off valve 52 circulates the fuel gas of the fuel gas tank 51 to a downstream side in a valve opening state. The regulator 53 is provided on the downstream side of the on-off valve 52 in the anode supply piping 501. The regulator 53 adjusts the pressure of the fuel gas on the upstream side of the injector 54 under control of the control device 60.

The injector 54 is provided on the downstream side of the regulator 53 in the anode supply piping 501. The injector 54 is arranged on an upstream side of a joining point of an anode circulation piping 502 described below in the anode supply piping 501. The injector 54 is an on-off valve which is electromagnetically driven according to a driving cycle and a valve opening time set by the control device 60. The control device 60 adjusts the supply amount of the fuel gas to be supplied to the fuel cell stack 20 by controlling the injector 54. The pressure sensor 59 measures an internal pressure, i.e., a supply pressure of the fuel gas on the downstream side of the injector 54 in the anode supply piping 501. The measurement result is transmitted to the control device 60.

The fuel gas circulation system 50B separates from a liquid component an anode off-gas discharged from the anode of the fuel cell stack 20, and then circulates the anode off-gas to the anode supply piping 501. The fuel gas circulation system 50B includes the anode circulation piping 502, a gas-liquid separator 57, a circulation pump 55 and a motor 56.

The anode circulation piping 502 is connected with an anode outlet of the fuel cell stack 20 and the anode supply piping 501 to form a circulation path of the fuel gas which leads to the anode supply piping 501 the anode off-gas discharged from the anode. The gas-liquid separator 57 is provided in the anode circulation piping 502, and separates a liquid component containing vapor from the anode off-gas and stores the liquid component in a state of liquid water. The circulation pump 55 is provided on the downstream side of the gas-liquid separator 57 in the anode circulation piping 502. The circulation pump 55 feeds a fuel off-gas flowing into the gas-liquid separator 57, to the anode supply piping 501 by driving the motor 56.

The fuel gas discharge system 50C discharges the anode off-gas and the liquid water stored in the gas-liquid separator 57 to the exhaust gas piping 306. The fuel gas discharge system 50C includes the anode discharge piping 504 and a discharge drain valve 58. The anode discharge piping 504 is connected with a discharge outlet of the gas-liquid separator 57 and the exhaust gas piping 306 to form a discharge drain path which discharges, from the fuel gas supply/discharge system 50, drain water discharged from the discharge outlet of the gas-liquid separator 57 and part of the anode off-gas passing in the gas-liquid separator 57. The discharge drain valve 58 is provided in the anode discharge piping 504, and opens and closes the anode discharge piping 504. For example, a diaphragm valve is used as the discharge drain valve 58. When the fuel cell system 10 generates power, the control device 60 makes a valve opening instruction to the discharge drain valve 58 at a predetermined timing. When the discharge drain valve 58 is opened, moisture and the anode off-gas stored in the gas-liquid separator 57 are discharged into the atmosphere through the exhaust gas piping 306.

The refrigerant circulation system 70 includes a refrigerant circulation path 79, a refrigerant circulation pump 74, a motor 75, a radiator 71, a radiator fan 72 and a stack temperature sensor 73.

The refrigerant circulation path 79 includes a refrigerant supply path 79A and a refrigerant discharge path 79B. The refrigerant supply path 79A is a piping which supplies a refrigerant to the fuel cell stack 20. The refrigerant discharge path 79B is a piping which discharges the refrigerant from the fuel cell stack 20. The refrigerant circulation pump 74 feeds the refrigerant of the refrigerant supply path 79A to the fuel cell stack 20 by driving the motor 75. The radiator 71 is blown with a wind by the radiator fan 72 and radiates heat to cool the internally circulating refrigerant. The stack temperature sensor 73 measures the temperature of the refrigerant in the refrigerant discharge path 79B. The measurement result of the temperature of the refrigerant is transmitted to the control device 60. The control device 60 detects a measured temperature of the stack temperature sensor 73 as the temperature of the fuel cell stack 20 to use to control the fuel cell system 10.

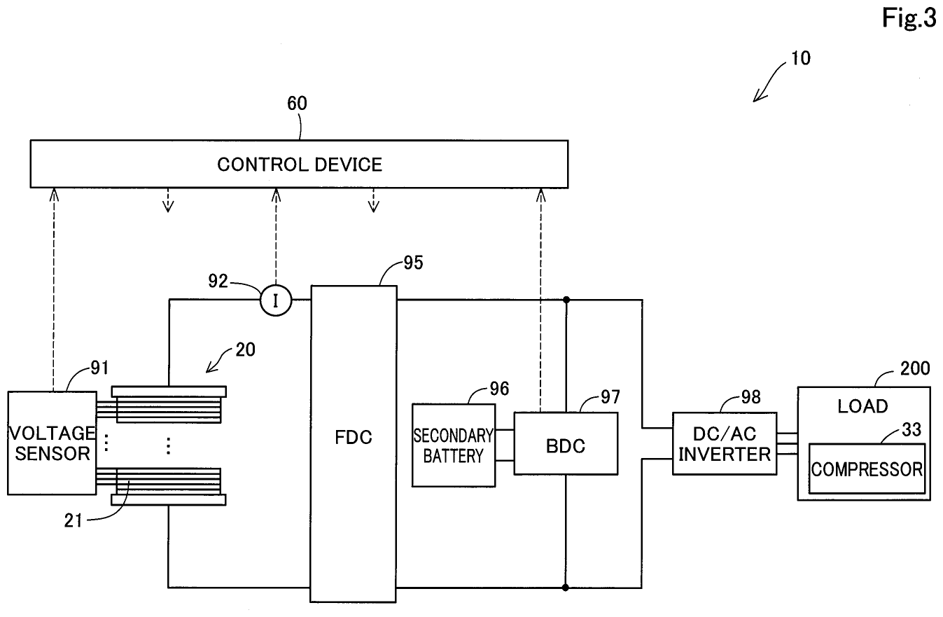

FIG. 3 is a schematic view illustrating an electrical configuration of the fuel cell system 10. The fuel cell system 10 includes an FC converter 95, a DC/AC inverter 98, a voltage sensor 91 and a current sensor 92.

The voltage sensor 91 is used to measure a voltage of the fuel cell stack 20. The voltage sensor 91 is connected with all of the fuel battery cells 21 of the fuel cell stack 20 respectively, and measures the voltage targeting at all of the fuel battery cells 21 respectively. The voltage sensor 91 transmits the measurement result of the voltage to the control device 60. Measured voltages of all of the fuel battery cells 21 measured by the voltage sensor 91 are summed up to measure a total voltage of the fuel cell stack 20. In addition, instead of the voltage sensor 91, the fuel cell system 10 may include a voltage sensor which measures voltages of both ends of the fuel cell stack 20. In this case, measured voltage values of the both ends are the total voltage of the fuel cell stack 20. The current sensor 92 measures an output current value of the fuel cell stack 20, and transmits the output current value to the control device 60.

The FC converter 95 is configured as, for example, a DC/DC converter, and functions as a circuit which controls the current of the fuel cell stack 20. The FC converter 95 controls the current outputted by the fuel cell stack 20 based on a current command value transmitted from the control device 60. The current command value is a value which indicates a target value of an output current of the fuel cell stack 20, and is set by the control device 60.

The DC/AC inverter 98 is connected with the fuel cell stack 20 and a load 200. The load 200 includes a drive motor which is a driving force source, and other auxiliary machines and electric machines in the fuel cell vehicle. The air compressor 33 of the above-described oxidizing gas supply/discharge system 30 is included in the load 200. The DC/AC inverter 98 converts direct current power outputted from the fuel cell stack 20 or a secondary battery 96 into alternating current power to supply to the load 200. Furthermore, when the drive motor included in the load 200 generates regenerative power, the DC/AC inverter 98 converts the regenerative power into the direct current power. The regenerative power converted into the direct current power by the DC/AC inverter 98 is stored in the secondary battery 96 via a battery converter 97.

The fuel cell system 10 further includes the secondary battery 96 and the battery converter 97. The secondary battery 96 functions as a power source of the fuel cell system 10 together with the fuel cell stack 20. The secondary battery 96 is charged by power generated by the fuel cell stack 20 or the above-described regenerative power. In addition, according to the present embodiment, the secondary battery 96 is configured as a lithium-ion battery, and has temperature characteristics that an allowable range of a charge/discharge amount remarkably narrows below the freezing point. The temperature characteristics of the secondary battery 96 will be described below.

The battery converter 97 is configured as a DC/DC converter, and controls charging/discharging of the secondary battery 96 according to an instruction of the control device 60. Furthermore, the battery converter 97 measures a State Of Charge (SO C) of the secondary battery 96 to transmit to the control device 60.

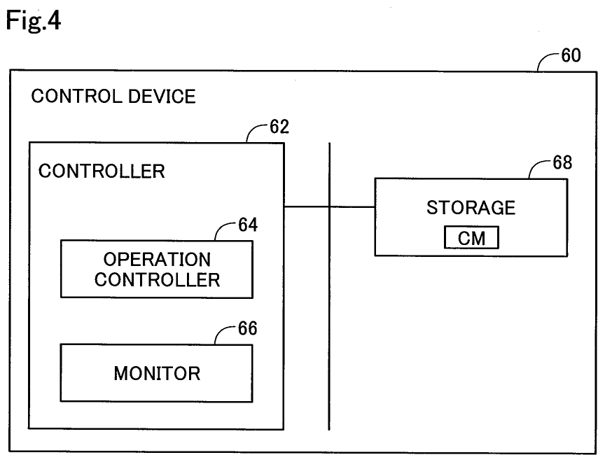

FIG. 4 is an internal block diagram of the control device 60. The control device 60 is also referred to as an Electronic Control Unit (ECU), and includes a controller 62 and a storage 68 which is configured as an external storage device such as an ROM or a hard disk. The controller 62 includes at least one processor and a main storage device. The processor executes programs or commands read from the storage 68 onto the main storage device so that the controller 62 exhibits various functions for controlling power generation of the fuel cell stack 20. It is noted that at least part of the functions of the controller 62 may be configured as hardware circuits.

The storage 68 stores various programs which are executed by the controller 62, parameters which are used to control the fuel cell system 10 and various maps which include a control map CM described below in a volatile fashion. The “volatile fashion” means that information is held in a storage device without being lost even when a power distribution state for the storage device is turned off. The controller 62 functions as an operation controller 64 and a monitor 66 by executing the various programs in the storage 68. The operation controller 64 controls the operation of the fuel cell system 10. The operation controller 64 executes a normal operation of causing the fuel cell stack 20 to generate power in response to an output request from the load 200 to the fuel cell system 10.

Furthermore, the operation controller 64 executes a warm-up operation for rapidly raising the temperature of the fuel cell stack 20. The warm-up operation is executed when a predetermined warm-up condition is satisfied during start processing described below and executed by the operation controller 64 upon activation of the fuel cell system 10. According to the present embodiment, the warm-up condition is satisfied when a measurement value of the outdoor temperature sensor 38 is a predetermined temperature or less. In other embodiments, the warm-up condition may be satisfied when, for example, the fuel cell system 10 is left as it is in a stop state for a given time or more in winter. Unlike the normal operation, during the warm-up operation, the operation controller 64 sets a target heat generation amount of the fuel cell stack 20, and controls the fuel cell stack 20 to generate power at the target heat generation amount irrespectively of the output request from the load 200.

During the warm-up operation according to the present embodiment, the operation controller 64 controls the oxidizing gas supply/discharge system 30 and the fuel gas supply/discharge system 50 such that a stoichiometric ratio of an oxidizing gas to be supplied to the fuel cell stack 20 is smaller than a stoichiometric ratio during the normal operation. “The stoichiometric ratio of the oxidizing gas” means a ratio of an amount of the oxidizing gas to be actually supplied with respect to an amount of an oxidizing gas which is theoretically necessary to generate requested generation power. This control increases a concentration overvoltage of the cathode, and lowers power generation efficiency of the fuel cell stack 20, so that the heat generation amount of the fuel cell stack 20 increases compared to the heat generation amount at a time of the normal operation, and it is possible to increase a temperature increase rate of the fuel cell stack 20. The stoichiometric ratio of the oxidizing gas during the warm-up operation may be, for example, approximately 1.0. It is noted that, during the warm-up operation according to the present embodiment, the operation controller 64 maintains supply amounts of the oxidizing gas and the fuel gas for the fuel cell stack 20 at predetermined supply amounts.

According to the present embodiment, while the warm-up operation is executed, the operation controller 64 performs control such that power outputted by the fuel cell stack 20 becomes predetermined constant power by taking characteristics of the secondary battery 96 described below into account. This constant power is desirably set to a value equal to or more than power which is expected to be consumed by the load 200 during the warm-up operation. The constant power is, for example, approximately 5 to 15 kW.

The monitor 66 monitors occurrence of a fuel gas concentration abnormality that a fuel gas concentration in an exhaust gas discharged from the exhaust gas piping 306 exceeds a predetermined allowable value based on the measurement result of the fuel gas sensor 311 during power generation of the fuel cell stack 20. The fuel gas concentration abnormality is detected when, for example, a large amount of the fuel gas is produced in the cathode of the fuel cell stack 20. When a fuel gas ionized in the anode moves to the cathode via the electrolyte membrane and is recombined with an electron in the fuel cell stack 20, the fuel gas is produced in the cathode. This production of the fuel gas in the cathode is likely to occur when a supply amount of the oxidizing gas for the cathode is insufficient. When the fuel gas is hydrogen as in the present embodiment, this fuel gas produced in the cathode is also referred to as “pumping hydrogen”. “The fuel gas produced in the cathode” in description of the present embodiment can be paraphrased as “pumping hydrogen”.

When the monitor 66 detects the fuel gas concentration abnormality during power generation of the fuel cell stack 20 during the warm-up operation, the operation controller 64 executes exhaust gas dilution control for reducing the fuel gas concentration in an exhaust gas. Exhaust gas dilution control will be described later.

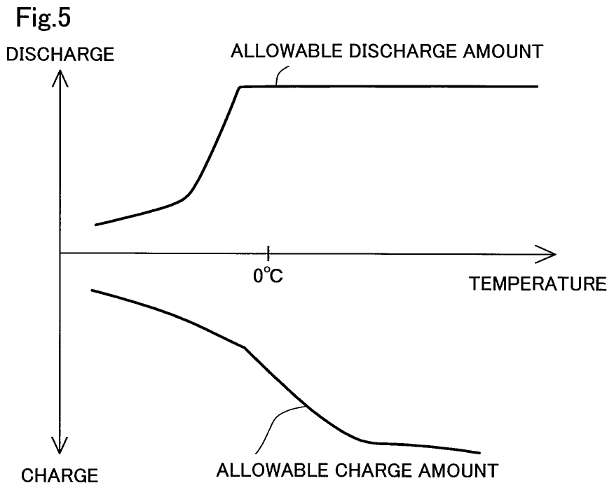

FIG. 5 is an explanatory view illustrating temperature characteristics of the secondary battery 96. When a secondary battery such as a lithium-ion battery goes below the freezing point and, more particularly, reaches −20 C.° (Celsius) or less, a range of chargeable/dischargeable power rapidly narrows. Hence, when generation power of the fuel cell stack 20 exceeds or becomes insufficient compared to requested power below the freezing point, there may be a case where it is difficult to store power of an exceeding amount in the secondary battery 96 or discharge power of an insufficient amount from the secondary battery 96. Hence, according to the present embodiment, during the warm-up operation, the generation power of the fuel cell stack 20 is controlled at the above-described constant power such that the charge/discharge amount of the secondary battery 96 falls in a predetermined range. Consequently, power of the fuel cell stack 20 is suppressed from fluctuating during execution of the warm-up operation, so that a load is suppressed from being applied to the secondary battery 96 whose allowable range of the charge/discharge amount is narrowed due to a low temperature. Consequently, deterioration of the secondary battery 96 such as elution of lithium of the secondary battery 96 due to an excessive load is suppressed.

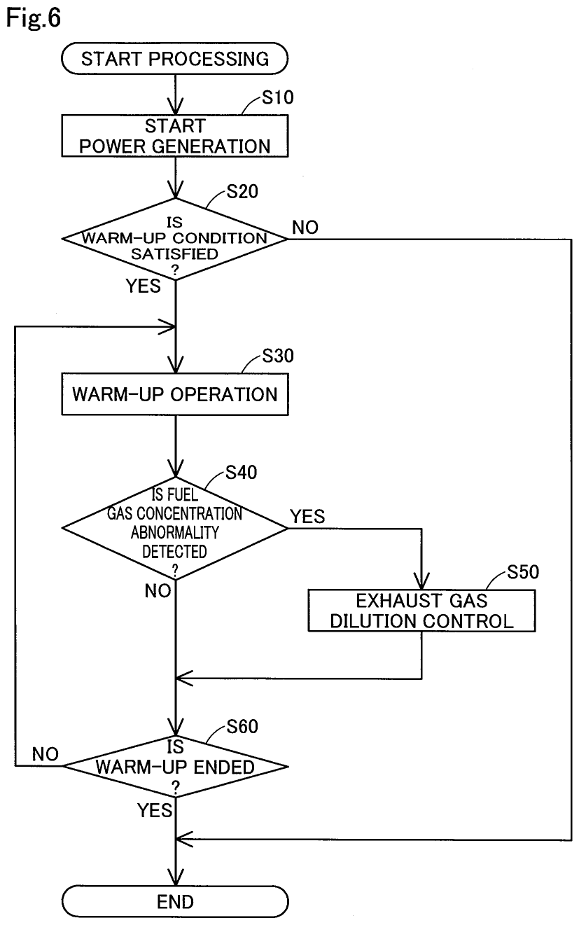

FIG. 6 is an explanatory view illustrating a flow of start processing executed by the operation controller 64 of the controller 62. The start processing is executed by the operation controller 64 when an activation operation is performed on the fuel cell vehicle, and operation start of the fuel cell system 10 is commanded.

In step S10, the operation controller 64 causes the fuel cell stack 20 to start power generation. More specifically, the operation controller 64 starts supply control of a reactive gas to the fuel cell stack 20 by the oxidizing gas supply/discharge system 30 and the fuel gas supply/discharge system 50. Furthermore, in addition to the above-described reactive gas supply control, the operation controller 64 starts temperature control for controlling the temperature of the fuel cell stack 20 by the refrigerant circulation system 70.

In step S20, the operation controller 64 determines whether or not the warm-up condition which is a warm-up operation start condition is satisfied. As described above, according to the present embodiment, when the measurement value of the outdoor temperature sensor 38 is the predetermined temperature or less, it is determined that the warm-up condition is satisfied. According to the present embodiment, a threshold temperature of the warm-up condition is the freezing point. In other embodiments, the threshold temperature of the warm-up condition may be a temperature lower than the freezing point, or may be a temperature which is higher than the freezing point and is near the freezing point. When the warm-up condition is not satisfied, the operation controller 64 finishes the start processing without executing the warm-up operation, and starts the normal operation.

When the warm-up condition is satisfied, the operation controller 64 executes the warm-up operation in step S30. When the warm-up operation is started, the operation controller 64 sets a target heat generation amount which is a target value of a heat generation amount of the fuel cell stack 20. When a current outdoor temperature or the temperature of the fuel cell stack 20 is lower, the operation controller 64 may set the target heat generation amount to a larger value. In this case, when setting the target heat generation amount, the operation controller 64 may use a map which is prepared in advance and stored in the storage 68.

Furthermore, as described above, during the warm-up operation, the operation controller 64 controls the oxidizing gas supply/discharge system 30 and the fuel gas supply/discharge system 50 such that the stoichiometric ratio of the oxidizing gas to be supplied to the fuel cell stack 20 becomes the predetermined stoichiometric ratio smaller than a stoichiometric ratio of the normal operation. The operation controller 64 controls the current of the fuel cell stack 20 by the FC converter 95 such that the fuel cell stack 20 generates power while generating heat at the target heat generation amount in a state where a reactive gas is supplied at the stoichiometric ratio for the warm-up operation.

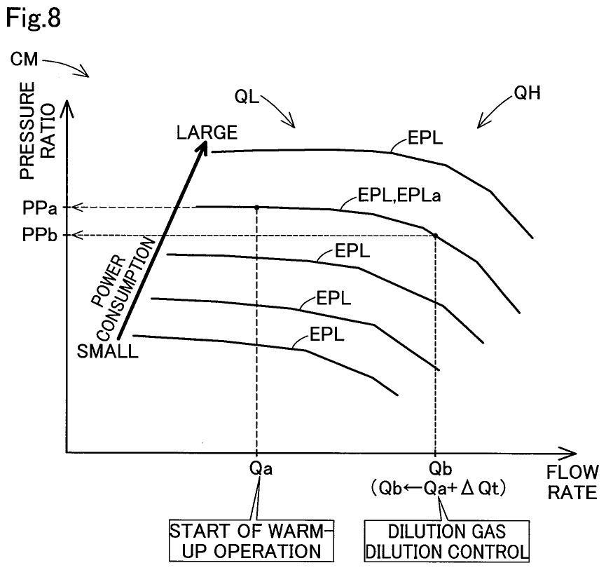

In addition, during the warm-up operation, the operation controller 64 drives the air compressor 33 such that the oxidizing gas is supplied to the fuel cell stack 20 at the above-described stoichiometric ratio. In this case, the operation controller 64 uses the control map CM described below and illustrated in FIG. 8. However, description of details of the control map CM will be made together in description of exhaust gas dilution control.

While the warm-up operation is executed, the operation controller 64 determines in step S40 whether or not the monitor 66 detects a fuel gas concentration abnormality. As described above, according to the present embodiment, when the fuel gas concentration in an exhaust gas measured by the fuel gas sensor 311 exceeds the predetermined allowable value, the monitor 66 detects the fuel gas concentration abnormality. When the fuel gas concentration abnormality is detected, the operation controller 64 executes exhaust gas dilution control for reducing the fuel gas concentration in the exhaust gas in step S50. The exhaust gas dilution control will be described later.

When the fuel gas concentration abnormality is not detected in step S40 or after the exhaust gas dilution control in step S50 is executed, the operation controller 64 determines whether or not to end the warm-up operation in step S60. The operation controller 64 determines whether or not a predetermined warm-up end condition is satisfied. According to the present embodiment, the warm-up end condition is satisfied when the temperature of the fuel cell stack 20 is a predetermined threshold temperature or more. It is noted that, in other embodiments, the warm-up end condition may be satisfied when, for example, temperatures of system auxiliary machines other than the fuel cell stack 20 become the threshold temperature or more. Furthermore, the warm-up end condition may be satisfied when a warm-up end time calculated based on the target heat generation amount passes.

When the warm-up end condition is satisfied, the operation controller 64 ends the warm-up operation, and finishes the start processing. The operation controller 64 starts the normal operation of the fuel cell stack 20 after the start processing is finished. On the other hand, when the warm-up end condition is not satisfied, the operation controller 64 returns to step S30, and continues the warm-up operation of causing the fuel cell stack 20 to generate heat at the target heat generation amount. The operation controller 64 repeatedly executes fuel gas concentration determination by the monitor 66 in step S40 at a predetermined control cycle until the warm-up end condition is satisfied in step S60.

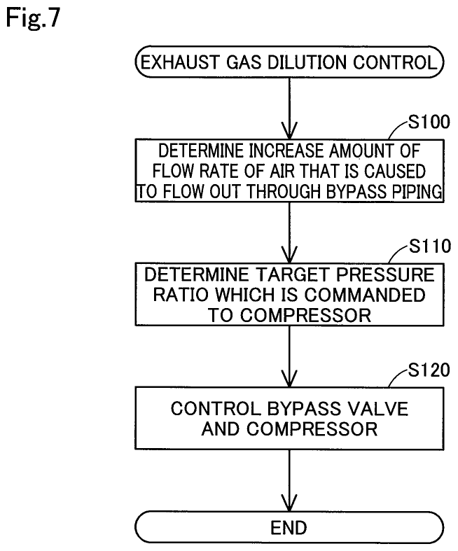

FIG. 7 is an explanatory view illustrating a flow of exhaust gas dilution control. According to the exhaust gas dilution control, the operation controller 64 increases a flow rate of air fed by the air compressor 33. Furthermore, the operation controller 64 controls the opening of the bypass valve 39 such that a ratio of the flow rate of air flowing out from the bypass piping 308 to the exhaust gas piping 306 with respect to the flow rate of air to be supplied to the fuel cell stack 20 increases. Consequently, a fuel gas concentration in an exhaust gas discharged from the exhaust gas piping 306 is reduced.

In step S100, the operation controller 64 determines an increase amount of the flow rate of the air that is caused to flow out to the exhaust gas piping 306 through the bypass piping 308. This increase amount of the flow rate is referred to as a “target bypass increase flow rate ΔQt”. The operation controller 64 determines the target bypass increase flow rate ΔQt for a measurement value of the fuel gas sensor 311 by using a map which defines a relationship that, when the fuel gas concentration in the exhaust gas is higher, the target bypass increase flow rate ΔQt is larger, and which is prepared in advance.

In step S110, the operation controller 64 determines a target pressure ratio to command to the air compressor 33 by using the target bypass increase flow rate ΔQt determined in step S100. According to the present embodiment, the operation controller 64 determines the target pressure ratio of the air compressor 33 such that an increase amount of the flow rate of the air flowing out from the bypass piping 308 and an increase amount of the flow rate of the air fed by the air compressor 33 become equal. The operation controller 64 uses the control map CM which uses the operation characteristics of the air compressor 33 and is described below to determine the target pressure ratio.

FIG. 8 is an explanatory view illustrating one example of the control map CM of the air compressor 33. The relationship based on the operation characteristics of the air compressor 33 is defined for the control map CM. The operation characteristics of the air compressor 33 are indicated by a relationship of each power consumption that the pressure ratio and the flow rate at which the air compressor 33 is driven with identical power consumption are associated on a one-on-on basis. A graph of each power consumption indicating this relationship is also referred to as an “equal power line EPL”. A decrease in the pressure ratio with respect to an increase in the flow rate is small, and the pressure ratio is maintained substantially constantly in a low flow rate region QL in which a flow rate of each equal power line EPL is relatively small. The phrase “substantially constantly” described herein includes a fluctuation range of approximately ±5%. A decrease in the pressure ratio with respect to the increase in the flow rate is larger in a high flow rate region QH in which the flow rate of each equal power line EPL is relatively large than in the low flow rate region QL. More specifically, the pressure ratio lowers like a quadratic function as the flow rate increases in the high flow rate region QH of each equal power line EPL. It is noted that, the flow rate of the air fed by the air compressor in the low flow rate region is larger than the flow rate of the air fed by the air compressor in the low flow rate region. The larger power consumption of the equal power line EPL is, the larger the pressure ratio determined for the same flow rate is. The operation controller 64 controls driving of the air compressor 33 by using the control map CM which defines the relationship which indicates the operation characteristics of the air compressor 33. The operation controller 64 uses this control map CM when the air compressor 33 is driven while the fuel cell stack 20 generates power during not only the warm-up operation but also the normal operation.

Operation control of the air compressor 33 at a time when the warm-up operation is started in step S30 in FIG. 6 will be described first, and then operation control of the air compressor 33 during exhaust gas dilution control will be described. At the time of start of the warm-up operation, the operation controller 64 selects power consumption of the air compressor 33 for the warm-up operation. The power consumption of the air compressor 33 for the warm-up operation is determined in advance according to power which the fuel cell stack 20 is caused to generate during the warm-up operation. The power which the fuel cell stack 20 is caused to generate during the warm-up operation and the power consumption of the air compressor 33 may be changed according to a current temperature of the fuel cell stack 20. As illustrated in FIG. 8, the operation controller 64 obtains a target pressure ratio PPa with respect to a target flow rate Qa of air fed by the air compressor 33 on an equal power line EPLa of the selected power consumption. This target flow rate Qa is determined based on the stoichiometric ratio of an oxidizing gas during the warm-up operation. The target flow rate Qa is a value included in the low flow rate region QL. The operation controller 64 commands the air compressor 33 to feed air compressed by the air compressor 33 according to the target pressure ratio PPa with power consumption for the warm-up operation.

In step S110 of the exhaust gas dilution control in FIG. 7, the operation controller 64 calculates a new target flow rate Qb of the air compressor 33 such that the flow rate of the air fed by the air compressor 33 increases by the target bypass increase flow rate ΔQt calculated in step S100. The target flow rate Qb is calculated as a value obtained by adding the target bypass increase flow rate ΔQt to the current target flow rate Qa of the air compressor 33. The operation controller 64 uses the control map CM illustrated in FIG. 8 to obtain a target pressure ratio PPb for the calculated new target flow rate Qb on the equal power line EPLa associated with power consumption for the warm-up operation. The target bypass increase flow rate ΔQt is determined as such a value that the new target flow rate Qb is included in the high flow rate region QH, and the target pressure ratio PPb is obtained as a value smaller than the target pressure ratio PPa at which the exhaust gas dilution control is started.

In step S120, the operation controller 64 controls the bypass valve 39 and the air compressor 33. More specifically, the operation controller 64 increases the opening of the bypass valve 39 according to the target bypass increase flow rate ΔQt such that the amount of air flowing in from the bypass piping 308 to the exhaust gas piping 306 increases by the target bypass increase flow rate ΔQt. At the substantially same time, the operation controller 64 drives the air compressor 33 such that the air compressor 33 feeds air compressed according to the new target pressure ratio PPb calculated in step S110 with the power consumption for the warm-up operation.

By controlling the air compressor 33 and the bypass valve 39 in step S120, the flow rate of the air fed by the air compressor 33 and the flow rate of the air flowing out to the exhaust gas piping 306 through the bypass piping 308 are increased. More specifically, a ratio of the flow rate of the air flowing out from the bypass piping 308 to the exhaust gas piping 306 with respect to the flow rate of the air to be supplied to the fuel cell stack 20 is increased. Consequently, it is possible to increase the amount of air contained in an exhaust gas discharged into the atmosphere through the exhaust gas piping 306 while suppressing a decrease in the amount of air to be supplied to the fuel cell stack 20. Consequently, it is possible to reduce a fuel gas concentration in the exhaust gas discharged into the atmosphere while suppressing a change in a power generation state of the fuel cell stack 20.

When ending exhaust gas dilution control, the operation controller 64 returns to the start processing in FIG. 6, and continues the warm-up operation until the warm-up end condition is satisfied in step S60. It is noted that, while the fuel gas concentration abnormality is detected in step S40 after execution of the exhaust gas dilution control, the operation controller 64 maintains the flow rate of the air set by the exhaust gas dilution control and fed by the air compressor 33 and the flow rate of the air bypassed through the bypass piping 308. When the fuel gas concentration abnormality is no longer detected in step S40 after execution of the exhaust gas dilution control, the operation controller 64 resets the flow rate of the air fed by the air compressor 33 and the flow rate of the air bypassed through the bypass piping 308 to the flow rates at a time of the normal warm-up operation.

As described above, when the fuel gas concentration abnormality is detected during the warm-up operation, the fuel cell system 10 executes exhaust gas dilution control for increasing the ratio of the flow rate of the air flowing out from the bypass piping 308 with respect to the flow rate of the air to be supplied to the fuel cell stack 20. Consequently, it is possible to reduce the fuel gas concentration in the exhaust gas while suppressing the decrease in the supply amount of the air to the fuel cell stack 20.

Furthermore, according to the exhaust gas dilution control according to the present embodiment, control is performed such that the increase amount of the flow rate of the air flowing out from the bypass piping 308 and the increase amount of the flow rate of the air fed by the air compressor 33 become equal. Consequently, even when the opening of the bypass valve 39 is increased by the exhaust gas dilution control, a supply flow rate of air for the cathode of the fuel cell stack 20 is suppressed from fluctuating. Consequently, it is possible to suppress the power generation state of the fuel cell stack 20 from changing, and cause the fuel cell stack 20 to stably continue power generation. Particularly when the warm-up operation with the reduced stoichiometric ratio of the oxidizing gas is executed as in the present embodiment, the fluctuation of the supply flow rate of the air for the fuel cell stack 20 significantly influences the power generation state and a heat generation amount of the fuel cell stack 20. Hence, from a viewpoint to stably continue the warm-up operation, an effect resulting from suppression of the fluctuation of the supply flow rate of the air for the fuel cell stack 20 by the exhaust gas dilution control is significant.

According to the exhaust gas dilution control according to the present embodiment, while power consumption of the air compressor 33 is constantly maintained by using the operation characteristics of the air compressor 33, the flow rate of the air fed by the air compressor 33 is increased. Consequently, power consumed by the fuel cell system 10 for the exhaust gas dilution control is suppressed from increasing, and suppress a decrease in system efficiency of the fuel cell system 10. Furthermore, it is possible to execute the exhaust gas dilution control without increasing the power generation amount of the fuel cell stack 20, so that it is possible to stably continue the warm-up operation while maintaining the power generation state of the fuel cell stack 20.

Furthermore, when the exhaust gas dilution control is executed during the warm-up operation during which the fuel cell stack 20 outputs only limited power, if the fluctuation of the power generation state of the fuel cell stack 20 is suppressed as described above, it is possible to suppress a great load from being applied to the secondary battery 96. When there are provided characteristics that an allowable range of charging/discharging narrows under low temperature environment similar to the secondary battery 96 according to the present embodiment, such an effect can be obtained as a particularly remarkable effect, and it is possible to effectively protect the secondary battery 96.

According to the present embodiment, the operation controller 64 drives the air compressor 33 at the flow rate in the low flow rate region QL in the control map CM before execution of the exhaust gas dilution control, and drives the air compressor 33 at the flow rate in the high flow rate region QH in the control map CM during the exhaust gas dilution control. Consequently, it is possible to control the flow rate of the air fed by the air compressor 33 while maintaining a pressure ratio of the air compressor 33 substantially constantly during other than the exhaust gas dilution control. On the other hand, according to the exhaust gas dilution control, it is possible to significantly increase the flow rate of the air fed by the air compressor 33 compared to the flow rate before execution of the exhaust gas dilution control. Consequently, it is possible to more effectively reduce the fuel gas concentration in the exhaust gas.

### 2. Other Embodiments

Various configurations described in the above embodiment can be modified as follows, for example. Each of the other embodiments described below is considered as one example of an embodiment for carrying out the technique according to the present disclosure similar to the above embodiment.

### Other Embodiment 1

Exhaust gas dilution control may be executed during power generation of the fuel cell stack 20 during other than the warm-up operation. The exhaust gas dilution control may be executed when the monitor 66 detects an exhaust gas concentration abnormality during the normal operation of the fuel cell stack 20. Consequently, it is possible to reduce a fuel gas concentration in an exhaust gas while suppressing the power generation state of the fuel cell stack 20 from fluctuating during the normal operation of the fuel cell stack 20. In this regard, it is supposed that a cause that the exhaust gas concentration abnormality occurs during the normal operation of the fuel cell stack 20 is that a supply failure of the oxidizing gas to the cathode causes production of a large amount of the fuel gas in the cathode.

### Other Embodiment 2

According to exhaust gas dilution control, control may not be performed such that the increase amount of the flow rate of air flowing out from the bypass piping 308 and the increase amount of the flow rate of air fed by the air compressor 33 become equal. That is, according to the exhaust gas dilution control, the flow rate of the air bypassed through the bypass piping 308 may be increased at an increase amount different from the increase amount of the flow rate of the air fed by the air compressor 33. In this case, a difference between the increase amount of the flow rate of the air flowing out from the bypass piping 308 and the increase amount of the flow rate of the air fed by the air compressor 33 is such a difference that a fluctuation of the power generation state of the fuel cell stack 20 caused by this difference desirably falls in an allowable range.

### Other Embodiment 3:

The air compressor 33 may not be configured as a compressor of a type which has operation characteristics which can change the flow rate of air to be fed while maintaining power consumption. In this case, the air compressor 33 may be configured as, for example, a roots type compressor which is configured not to include an impeller. The roots type compressor generally has difficulty in performing control to change the flow rate of the air to be fed while maintaining power consumption. Therefore, when the air compressor 33 is configured as the roots type compressor, power to be supplied to the compressor may not be maintained constantly during exhaust gas dilution control.

### Other Embodiment 4

During exhaust gas dilution control, the operation controller 64 may increase the flow rate of air fed by the air compressor 33 while keeping a substantially constant pressure ratio by using the low flow rate region QL in the control map CM. During the exhaust gas dilution control, the operation controller 64 may control the flow rate of the air fed by the air compressor 33 without using the control map CM which defines a relationship which indicates operation characteristics of the air compressor 33.

### 3. Others

Part or all of functions and processing realized by software in the above embodiments may be realized by hardware. Furthermore, part or all of functions and processing realized by hardware may be realized by software. Various circuits such as integrated circuits, discrete circuits or circuit modules formed by combining these circuits can be used as hardware.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to an aspect of the present disclosure, a fuel cell system is provided. The fuel cell system according to this aspect includes: a fuel cell stack which includes a cathode to which an oxidizing gas is supplied and an anode to which a fuel gas is supplied; an oxidizing gas supply/discharge system which executes supply control of the oxidizing gas to the cathode, and includes a cathode supply piping which is connected with an inlet of the cathode, an exhaust gas piping which is connected with an outlet of the cathode and discharges into an atmosphere an exhaust gas containing a cathode off-gas discharged from the cathode, a bypass piping which connects the cathode supply piping and the exhaust gas piping, an air compressor which compresses air containing the oxidizing gas to feed to the cathode supply piping, and a bypass valve which adjusts a flow rate of the air flowing into the bypass piping; a fuel gas supply/discharge system which executes supply control of the fuel gas to the anode; a fuel gas sensor which is provided in the exhaust gas piping, and detects a fuel gas concentration in the exhaust gas; a controller which controls operations of the oxidizing gas supply/discharge system and the fuel gas supply/discharge system, and controls power generation of the fuel cell stack, and, when detecting a fuel gas concentration abnormality that the fuel gas concentration exceeds a predetermined allowable value during the power generation of the fuel cell stack, the controller increases the flow rate of the air fed by the air compressor, and controls an opening of the bypass valve to execute exhaust gas dilution control for increasing a ratio of the flow rate of the air flowing out from the bypass piping to the exhaust gas piping with respect to the flow rate of the air to be supplied to the fuel cell stack.

When the fuel gas concentration in the exhaust gas exceeds the allowable value, the fuel cell system according to this aspect can increase the flow rate of the air flowing out to the exhaust gas piping through the bypass piping by exhaust gas dilution control while suppressing the increase in the supply flow rate of air to the fuel cell stack. Consequently, it is possible to reduce the fuel gas concentration in the exhaust gas while suppressing a change in a power generation state of the fuel cell stack.

(2) In the fuel cell system according to the above aspect, the controller may execute a warm-up operation of raising a temperature of the fuel cell stack upon activation of the fuel cell stack, and execute the exhaust gas dilution control when detecting the fuel gas concentration abnormality during execution of the warm-up operation.

When the fuel gas concentration in the exhaust gas increases during execution of the warm-up operation, the fuel cell system according to this aspect can reduce the fuel gas concentration in the exhaust gas by exhaust gas dilution control. Furthermore, as described above, according to the exhaust gas dilution control, it is possible to suppress the fuel gas concentration in the exhaust gas while suppressing the change in the power generation state of the fuel cell stack. Consequently, it is possible to suppress the power generation state of the fuel cell stack from fluctuating, and suppress a temperature increase rate of the fuel cell stack during the warm-up operation from lowering by the exhaust gas dilution control.

(3) During the exhaust gas dilution control, the controller of the fuel cell system according to the above aspect may perform control such that an increase amount of the flow rate of the air flowing out from the bypass piping and an increase amount of the flow rate of the air fed by the air compressor become equal.

The fuel cell system according to this aspect further suppresses the fluctuation of the supply flow rate of air for the cathode of the fuel cell stack by exhaust gas dilution control. Consequently, it is possible to further suppress the power generation state of the fuel cell stack from changing by executing the exhaust gas dilution control.

(4) In the fuel cell system according to the above aspect, the air compressor may be configured to change the flow rate of the air to be fed while maintaining power consumption, the air compressor may be driven by power of the fuel cell stack, and during the exhaust gas dilution control, the controller may increase the flow rate of the air fed by the air compressor while constantly maintaining power to be supplied from the fuel cell stack to the air compressor.

The fuel cell system according to this aspect can suppress power consumption in the air compressor from increasing, and suppress a necessity to increase a power generation amount of the fuel cell stack by exhaust gas dilution control. Consequently, it is possible to further suppress the power generation state of the fuel cell stack from fluctuating by executing the exhaust gas dilution control.

(5) In the fuel cell system according to the above aspect, when the air compressor is driven with same power consumption, a pressure ratio of a pressure of the air flowing into the air compressor with respect to a pressure of the air fed by the air compressor, and the flow rate of the air fed by the air compressor may be associated on a one-on-one basis, a decrease in the pressure ratio with respect to an increase in the flow rate of the air fed by the air compressor in a low flow rate region may be smaller than the decrease in the pressure ratio with respect to the increase in the flow rate of the air fed by the air compressor in a high flow rate region in which the flow rate of the air fed by the air compressor is larger than the flow rate of the air fed by the air compressor in the low flow rate region, and the controller may drive the air compressor at a target flow rate included in the low flow rate region before the execution of the exhaust gas dilution control, and drive the air compressor at a target flow rate included in the high flow rate region during the exhaust gas dilution control.

The fuel cell system according to this aspect can significantly increase the flow rate of air fed by the air compressor by exhaust gas dilution control while maintaining power consumption. Consequently, it is possible to effectively increase the fuel gas concentration in the exhaust gas.

The present disclosure can be realized as various aspects, and can be realized as aspects such as a control method of the fuel cell system, a computer program which causes a computer to execute the control method, and a non-transient recording medium having the computer program recorded thereon in addition to the fuel cell system.

What is claimed is:

1. A fuel cell system comprising:
a fuel cell stack that includes a cathode to which an oxidizing gas is supplied and an anode to which a fuel gas is supplied;
an oxidizing gas supply/discharge system configured to execute supply control of the oxidizing gas to the cathode, the oxidizing gas supply/discharge system including a cathode supply piping connected with an inlet of the cathode, an exhaust gas piping that is connected with an outlet of the cathode and discharges into an atmosphere an exhaust gas containing a cathode off-gas discharged from the cathode, a bypass piping that connects the cathode supply piping and the exhaust gas piping, an air compressor configured to compress air containing the oxidizing gas to feed to the cathode supply piping, and a bypass valve configured to adjust a flow rate of the air flowing in the bypass piping;
a fuel gas supply/discharge system configured to execute supply control of the fuel gas to the anode;
a fuel gas sensor that is provided in the exhaust gas piping, and configured to detect a fuel gas concentration in the exhaust gas;
a controller configured to control operations of the oxidizing gas supply/discharge system and the fuel gas supply/discharge system, and control power generation of the fuel cell stack,
wherein, when detecting a fuel gas concentration abnormality that the fuel gas concentration exceeds a predetermined allowable value during the power generation of the fuel cell stack, the controller increases a flow rate of the air fed by the air compressor, and controls an opening of the bypass valve to execute exhaust gas dilution control for increasing a ratio of a flow rate of the air flowing out from the bypass piping to the exhaust gas piping with respect to a flow rate of the air to be supplied to the fuel cell stack.

2. The fuel cell system according to claim 1, wherein
the controller executes a warm-up operation of raising a temperature of the fuel cell stack upon activation of the fuel cell stack, and executes the exhaust gas dilution control when detecting the fuel gas concentration abnormality during execution of the warm-up operation.

3. The fuel cell system according to claim 1, wherein,
during the exhaust gas dilution control, the controller performs control such that an increase amount of the flow rate of the air flowing out from the bypass piping and an increase amount of the flow rate of the air fed by the air compressor become equal.

4. The fuel cell system according to claim 1, wherein
the air compressor configured to change the flow rate of the air to be fed while maintaining power consumption,
the air compressor is driven by power of the fuel cell stack, and during the exhaust gas dilution control, the controller increases the flow rate of the air fed by the air compressor while constantly maintaining power to be supplied from the fuel cell stack to the air compressor.

5. The fuel cell system according to claim 4, wherein
when the air compressor is driven with same power consumption, a pressure ratio of a pressure of the air flowing into the air compressor with respect to a pressure of the air fed by the air compressor, and the flow rate of the air fed by the air compressor are associated on a one-on-one basis,
a decrease in the pressure ratio with respect to an increase in the flow rate of the air fed by the air compressor in a low flow rate region is smaller than the decrease in the pressure ratio with respect to the increase in the flow rate of the air fed by the air compressor in a high flow rate region in which the flow rate of the air fed by the air compressor is larger than the flow rate of the air fed by the air compressor in the low flow rate region, and
the controller drives the air compressor at a target flow rate included in the low flow rate region before the execution of the exhaust gas dilution control, and drives the air compressor at a target flow rate included in the high flow rate region during the exhaust gas dilution control.

6. A control method of a fuel cell system comprising a fuel cell stack, the control method comprising:
controlling an oxidizing gas supply/discharge system that includes a cathode supply piping connected with an inlet of the fuel cell stack, an air compressor configured to compress air containing an oxidizing gas to feed to the cathode supply piping, an exhaust gas piping that is connected with an outlet of the cathode and discharges into an atmosphere an exhaust gas containing a cathode off-gas discharged from the cathode, a bypass piping that connects the cathode supply piping and the exhaust gas piping, and a bypass valve configured to adjust a flow rate of the air flowing in the bypass piping, supplying the oxidizing gas to the cathode, controlling a fuel gas supply/discharge system, and supplying a fuel gas to an anode of the fuel cell stack to cause the fuel cell stack to generate power;
monitoring occurrence of a fuel gas concentration abnormality that a fuel gas concentration in the exhaust gas exceeds a predetermined allowable value during the power generation of the fuel cell stack; and
when detecting the fuel gas concentration abnormality, increasing a flow rate of the air fed by the air compressor, and controlling an opening of the bypass valve to execute exhaust gas dilution control for increasing a ratio of a flow rate of the air flowing out from the bypass piping to the exhaust gas piping with respect to a flow rate of the air to be supplied to the fuel cell stack.
